(19) United States
(12) Patent Application Publication
(10) Pub. No.: US 2023/0366060 A1
(43) Pub. Date: Nov. 16, 2023

(54) METHOD AND DEVICE FOR THE PURIFICATION OF POWDERS

(71) Applicants: L'AIR LIQUIDE SOCIÉTÉ ANONYME POUR L'ÉTUDE ET L'EXPLOITATION DES PROCÉDÉS GEORGES CLAUDE, PARIS (FR); AddUP, CEBAZAT (FR)

(72) Inventors: Sébastien DOUBLET, JOUY-EN-JOSAS (FR); Eric VERNA, JOUY-EN-JOSAS (FR); Olivier DEBELLEMANIERE, JOUY-EN-JOSAS (FR); Marc ROSAIN-GUEU, JOUY-EN-JOSAS (FR)

(21) Appl. No.: 18/246,809

(22) PCT Filed: Sep. 27, 2021
(86) PCT No.: PCT/EP2021/076493

§ 371 Date: Mar. 27, 2023

(30) Foreign Application Priority Data
Sep. 29, 2020 (FR) 2009916

(51) Int. Cl. C22B 9/14; C22B 9/02; C22B 9/10

(52) U.S. Cl. CPC C22B 9/14; C22B 9/026; C22B 9/10

(57) ABSTRACT

A method for purifying a powder including grains and contaminants, includes preparing a suspension including the metal powder and a solvent; then while applying mechanical energy to the suspension; dispersing the grains and the contaminants in the solvent; removing the contaminants and the solvent, and drying the grains under a controlled atmosphere.

### TECHNICAL FIELD OF THE INVENTION

The technical field of the invention is that of the purification of metal powders for use in an additive manufacturing method.

TECHNOLOGICAL BACKGROUND OF THE INVENTION During the manufacture of metal powders, mainly in methods using plasmas or electric arcs, or during their use in additive manufacturing by known so-called “laser beam melting” or “electron beam melting” techniques, part of the molten metals is superheated and vaporised or ejected in the form of microdroplets or vapour into the surrounding atmosphere of the method in progress. Some of the micro-droplets then deposit onto the surface of the powder grains, forming satellites, involving a degradation in the sphericity of the powder grains. The reduction in the sphericity of the powder grains directly influences their ability to be spread or distributed in the final method.

Although the surrounding atmosphere of the method is generally comprised of mostly neutral gases such as argon, nitrogen or helium, it always contains a residual content of impurities such as oxygen or moisture. Some additive manufacturing machines do not control the oxygen content below 1000 ppm, which is sufficient to oxidise the microdroplets and vapours generated. Oxidised vapour condenses into highly oxidised nano-sized particles which can also be deposited onto the powder grains. Pollution of powder batches by these oxidised particles adversely affects quality of the powders through a significant increase in oxygen content and an increase in hygiene and safety risks during their handling and use. The increase in the oxygen content of the powder batches degrades mechanical characteristics of the parts thus produced by additive manufacturing. Finally, the presence of the particles, even partially oxidised, greatly reduces lower flammability limits of the powder batches and can yield health problems when handling them.

U.S. Pat. No. 7,572,315 provides a method for purifying metal powders in order to reduce the amount of contaminants in powder batches. The method involves suspending metal powder including contaminants in a solution including, for example, alcohol or acetone, followed by separating the contaminants by means of intense ultrasonic vibrations. When the contaminants are suspended in the solution, a recovery step comprising sieving or centrifuging, as well as filtration makes it possible to recover the metal powder. However, no measures are taken to avoid the contaminants redepositing onto the powder grains during the recovery stage, reducing efficiency of the purification method.

### SUMMARY OF THE INVENTION

The invention provides a solution to the problems previously discussed, by providing a reproducible method for purifying metal powders, whether new or to be recycled, for obtaining a metal powder including a reduced oxygen content and an absence of satellites on the surface of the powder grains.

The invention relates to a method for purifying a powder including grains and contaminants, including:
a step of preparing a suspension including the powder and a solvent;
then while applying mechanical energy to the suspension:
   a step of dispersing the powder grains and contaminants in the solvent;
   a step of removing the contaminants and the solvent;
a step of drying the grains under a controlled atmosphere.

The contaminants include highly oxidised particles that may have been deposited onto the surface of the powder grains, as well as satellites on the surface of the powder grains.

Mechanical energy applied to the suspension is transmitted to the contaminants and to the grains, allowing some of the contaminants to be lifted off the powder grains. Mechanical energy enables the satellites to be lifted off the powder grains more easily as the adhesion force between grains and satellites is low. Mechanical energy applied to the suspension during the removal step avoids the contaminants being redeposited onto the powder grains. Thus the contaminants are effectively removed from the powder. The oxygen content of the powder thus purified is reduced. The powder grains, being free of surface contaminants, have a high sphericity.

In addition to the characteristics just discussed in the previous paragraphs, the method according to the invention may have one or more of the following additional characteristics, considered individually or according to any technically possible combinations:
mechanical energy is derived from stirring and/or sonicating the suspension;
the powder:solvent volume ratio in the suspension is between 1:1 and 1:50;
the powder:solvent volume ratio in the suspension is between 1:10 and 1:30;
the preparation step, dispersion step and removal step are carried out consecutively several times;
the method comprises a quality control step;
the drying step is triggered when an indicator generated by the quality control step is activated;
the quality control step is an analysis of the settling rate of a control suspension formed by the powder grains from the removal step mixed in the solvent, the indicator of the quality control step being activated if the settling rate reaches a threshold;
the quality control step comprises measuring the relative turbidity of the control suspension, the indicator of the quality control step being activated if the average transmission of a light intensity through the control suspension is greater than 70%, and preferably greater than 85%;
the relative turbidity measurement can be carried out using a technology based on the light scattering principle;
the duration of the removal step is less than 10 minutes per 100 grams of powder;
the flow rate of the removal step is greater than 0.5 L/min and preferably 1 L/min;
the removal step implements filtration;
the controlled atmosphere includes a neutral gas such as argon or nitrogen or a mixture of argon and nitrogen;
the controlled atmosphere includes several neutral gases.
the controlled atmosphere has an oxygen content of less than 1000 ppm, preferably less than 100 ppm;
the temperature of the grains is less than 150° C. during the drying step;
the method includes a step of sieving out so-called macroscopic contaminants, being contaminants whose size is greater than the size of the grains.

The term “sonication” refers to the treatment with ultrasound.

The invention also relates to a device configured to implement the purification method according to the invention, the device further comprising:
a reactor;
a mechanical energy source; and
a removal means; and
a drying means.

The invention and its different applications will be better understood upon reading the following description and examining the accompanying figures.

### BRIEF DESCRIPTION OF THE FIGURES

The figures are set forth by way of illustrating and are in no way limiting purposes of the invention.

FIG. 1 schematically shows a first mode of implementation of a purification method according to the invention.

FIG. 2 schematically shows a second mode of implementation of the purification method according to the invention.

FIG. 3 schematically shows a particle size distribution of a powder.

FIG. 4 schematically shows an embodiment of a purification device according to the invention.

FIG. 5a shows an image of a non-purified powder.

FIG. 5b shows an image of a purified powder.

### DETAILED DESCRIPTION

The figures are set forth by way of illustrating and are in no way limiting purposes of the invention. Unless otherwise specified, a same element appearing in different figures has a unique reference.

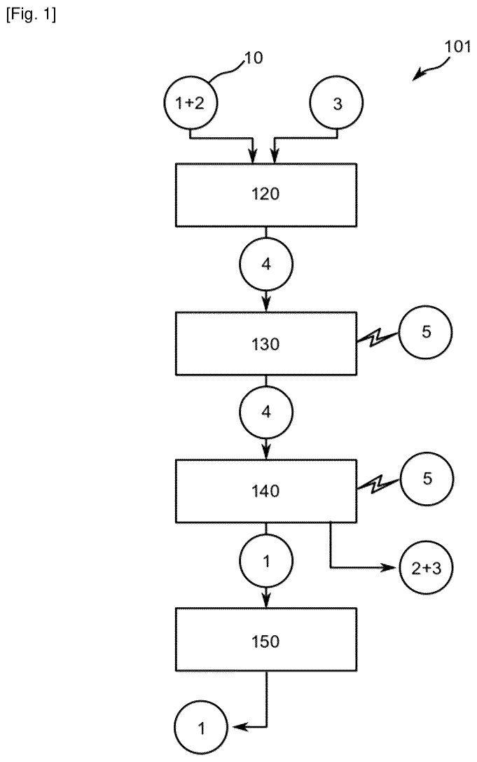

FIG. 1 shows a first mode of implementation of a method 101 for purifying a powder 10 including grains 1 and contaminants 2. The grains 1 are generally between a few micrometres and a hundred micrometres in size. The powder 10 may be “new”, that is from a powder manufacturing method, or “to be recycled”, that is from an additive manufacturing method. The contaminants 2 may be, for example, particles of generally nanometric size, which may be oxidised or may form satellites on the surface of the grains 1.

The method 101 includes a step of preparing 120 a suspension 4 including the powder 10 and a solvent 3. Advantageously, the solvent 3 has a significant physico-chemical affinity with the contaminants 2. For example, the solvent 3 may have a high wettability towards the contaminants 2. The solvent 3 can also modify the zeta potential of the grains 1 and the contaminants 2 suspended in the solvent 3. The zeta potential represents the electric charge that a particle acquires by virtue of the ions or molecules that surround it when it is in a solution. The zeta potential can for example be influenced by the pH of the solution. The physico-chemical affinity of the solvent 3 with the contaminants 2 will facilitate separation of the contaminants 2 from the grains 1 and avoid the contaminants 2 being redeposited onto the grains 1 at a later stage. The solvent 3 can for example be an alcohol or an alcoholic solution. The powder:solvent volume ratio within the suspension 4 is between 1:1 and 1:50 and preferably between 1:10 and 1:30. The concentration of the solvent 3 should be equal to or in excess of the powder concentration 10 to allow dispersion of the contaminants 2. At a powder:solvent volume ratio of 1:10, the solvent 3 is sufficiently in excess, allowing proper dispersion of the contaminants 2. Stirring the suspension 4 avoids the formation of agglomerates. However, in order to further limit formation of agglomerates, the powder 10 can advantageously be poured into the solvent 3.

The method 101 is compatible with the use of CO₂ in the supercritical phase as the solvent 3 to produce the suspension 4. For this, it is sufficient that the manufacturing device can maintain the supercritical state of CO₂, that is a pressure greater than 70 bar and a temperature greater than 35° C. Removal of the solvent 3 and contaminants 2 should be performed by filtration by controlling the pressure gradient by means of a weir.

The method 101 comprises a dispersion step 130 comprising separating the grains 1 and the contaminants 2 by means of mechanical energy 5 applied to the suspension 4 and dispersing them into the solvent 3. Mechanical energy 5 separates the contaminants 2 from each grain 1 and disperses the contaminants 2 homogeneously within the suspension 4. The dispersion step 130 is performed following the preparation step 120. The duration of the dispersion step 130 is adjusted so that the grains 1 and the contaminants 2 are homogeneously dispersed within the suspension 4. The duration of the dispersion step 130 may for example be between 1 min and 10 min. Mechanical energy 5 may be derived from stirring of the solution 4 performed by stirring means. The stirring means may for example comprise motor-driven blades or paddles. Mechanical energy 5 may also be derived from sonification of the suspension 4 performed by means of an ultrasonic assembly. The ultrasonic assembly may, for example, include a sonotrode immersed in the suspension 4, excited by an ultrasonic source. Advantageously, mechanical energy 5 may result from the combined action of stirring and sonication within the solution 4. Mechanical energy 5 is advantageously high so that all the contaminants 2 are separated from the grains 1 and dispersed efficiently in the suspension 4. However, heat dissipated by mechanical energy 5 should preferably not exceed a boundary value beyond which the solvent 3 heats up and can evaporate. For this, the stirring speed and/or the level of sonication are preferably set to the maximum values that do not heat up the solvent 3.

By the term “stirring of the solution”, it is meant mechanical stirring of the solution.

For example, the speed of the stirring means is between 5000 rpm and 20000 rpm. by way of example, the inventors achieve a satisfactory dispersion with stirring performed by a vertical blade rotating at a speed between 13000 rpm and 17000 rpm for 10 min.

Sonification can be performed by means of ultrasound with a wavelength of, for example, between 20 kHz and 1 MHz. However, depending on the type of dispersion desired, a narrower range may be selected.

For example, sonication with a so-called low wavelength, between 20 kHz and 30 kHz, allows formation of large cavitation bubbles. For example, at 25 kHz, bubbles are between 100 μm and 150 μm in size. The formation of these bubbles induces powerful cleaning and thus efficient separation of the contaminants 2.

According to another example, sonication with a so-called medium wavelength, between 40 kHz and 70 kHz, makes it possible to form cavitation bubbles of ten times smaller size. The impact force from breaking up the cavitation bubbles is then lower but the cavitation bubbles are more numerous. In this case, the bubbles rather induce a fine cleaning. In one example of the implementation of the invention, a satisfactory dispersion is obtained for example with a sonication frequency of 45 kHz.

According to another example, sonication with a so-called megasonic wavelength, in the order of 1 MHz, allows very gentle cleaning by virtue of cavitation bubbles of submicrometre size. Megasonic wavelengths are used, for example, in the field of microelectronics to clean substrates. Megasonic sonication also includes a microcurrent phenomenon induced by pressure gradients produced by the standing ultrasonic waves. Microcurrents can appear below the cavitation threshold and occur on a characteristic scale of a few micrometres to a few centimetres.

It is quite contemplatable to perform sonication at different frequencies in order to disperse different types of contaminants 2.

Purification of the powder advantageously benefits from the combination of several operating parameters as described previously. For example, powder purification is improved when the stirring speed is between 5000 rpm and 20000 rpm and when the suspension has a volume ratio between 1:1 and 1:50, or even between 1:10 and 1:30. The purification of the powder is further improved when sonication is also applied to the suspension with a frequency between 20 kHz and 1 MHz.

Mechanical energy is not derived from centrifugation, however intense. If the suspension is actually moved in the reference frame of the laboratory to carry out the centrifugation. However, it is a question of mimicking the effect of gravity in order to reduce the decantation time. Thus, in the reference frame of the suspension being centrifuged, said suspension is at rest and only under the influence of intense gravity. There is therefore no mechanical energy as such applied to the suspension.

The method 101 comprises a step of removing 140 the contaminants 2 and the solvent 3 from the suspension 4 in order to keep only the powder grains 1. The removal 140 implements a removal means. The removal means implements, for example, filtration, preferably under vacuum. In this case, the removal means comprises a filter configured to allow only particles smaller than the size of the grains 1 to pass through. The removal means may also implement centrifugation. In order to limit the likelihood of contaminants 2 being redeposited onto the grains 1 during removal 140, mechanical energy 5 is kept throughout the removal step 140. Advantageously, the duration of the removal step 140 is also reduced so as to further reduce the likelihood of the contaminants 2 redepositing onto the grains 1 or agglomerating together. Advantageously, the duration of the removal step 140 is less than 10 minutes per 100 grams of powder 10. In the case of filtration, the duration of the removal step 140 can be defined by the filtration flow rate, greater than 0.5 L/min, and preferably greater than 1 L/min.

The grains 1, still wetted by a residue of solvent 3, are recovered and then undergo a drying step 150 during which the rest of solvent 3 evaporates. In order to limit oxidation of the grains 1, the drying step 150 is carried out in a drying means comprising a controlled atmosphere. The controlled atmosphere includes a neutral gas such as argon or nitrogen. The oxygen content in the controlled atmosphere is low, advantageously below 1000 ppm and preferably below 100 ppm. The drying step 150 should preferably not degrade quality of the grains 1. The drying temperature is below the melting point of the grains 1 and preferably below 150° C.

The controlled atmosphere may also include a number of neutral gases including for example nitrogen and/or argon.

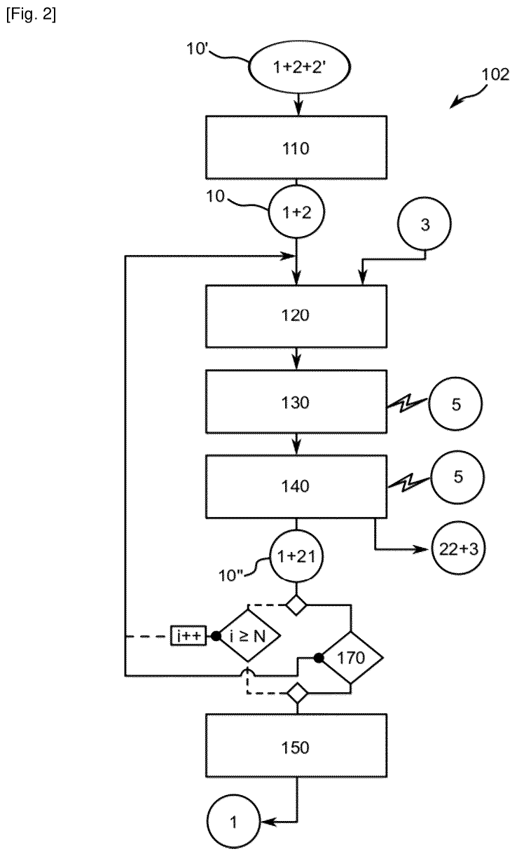

FIG. 2 shows a second mode of implementation of the method 102. In FIG. 2, the method 102 starts with a raw powder 10′ including the grains 1, contaminants 2 and macroscopic contaminants 2′. The macroscopic contaminants 2′ are larger than the size of the grains 1, in the order of several hundred microns. They may be aggregates of grains 1, non-spherical melt or packaging residues.

The method 102 includes a step of sieving 110 the raw powder 10′ during which macroscopic contaminants 2′ are removed, thus obtaining the powder 10 as defined with reference to FIG. 1. Sieving 110 may be performed dry or in the liquid phase, in the latter case using the solvent 3.

During the removal step 140, it is possible that a first part 21 of the contaminants 2 is not removed with the solvent 3 and to have an unsatisfactory quality control 170. The first part 21 of the contaminants 2 may have redeposited onto the grains 1 during the removal step 140 or may not have separated from the grains 1 during the dispersion step 130. At the end of the removal step 140, only the solvent 3 and a second part 22 of the contaminants 2 have been removed. At the end of the removal step 140, the grains 1 and the first part 21 of the contaminants 2 form a partially purified powder 10″. The efficiency of the method 102 can be improved by performing the preparation step 120, the dispersion step 130 and the removal step 140 consecutively and several times. In FIG. 2, the preparation 120, dispersion 130 and removal 140 steps are performed N times. By performing the preparation step 120 again, the suspension is prepared again, this time comprising the partially purified powder 10″ and the solvent 3. As the preparation step 120, the dispersion step 130 and the removal step 140 are performed, the first part 21 of the contaminants 2 not removed upon firstly performing the removal step 140 will be increasingly reduced, thereby improving efficiency of the method 102.

As an alternative to repeatedly performing the preparation 120, dispersion 130 and removal 140 steps, the method 102 may include a quality control step 170, performed following the removal step 140. The quality control step 170 makes it possible to qualitatively determine removal of contaminants 2 following the dispersion 130 and removal 140 steps. As the grains 1 have a shorter settling time than the contaminants 2 and the solvent 3, the quality control step 170 advantageously comprises an analysis of the settling rate of the partially purified powder 10″. The settling rate analysis is performed on a sample of the partially purified powder 10″ mixed with the solvent 3 at a powder:solvent volume ratio of 1:4 so as to form a control suspension. The settling rate of the control suspension is analysed over a settling duration of between 15 min and 30 min. If the settling rate is sufficiently high, that is if the settling height of the grains 1 is sufficiently low at the end of the settling duration, for example less than 30% of the height of the control suspension, an indicator is generated. Otherwise, the preparation 120, dispersion 130 and removal 140 steps are performed again. The quality control step 170 allows the previous steps 120, 130, 140 to be triggered only when necessary, thus reducing the time required to carry out the method 102.

The settling duration can advantageously be reduced by resorting to a centrifugation of the control suspension. The settling rate analysis may also be supplemented by a measurement of the relative turbidity of the control suspension. The relative turbidity measurement can be carried out on the principle of static light scattering. For this purpose, the control suspension is poured into a standard cylindrical transparent flask, through which a measurement of the transmitted and backscattered light intensity is carried out. Measurement of the light intensity is carried out over the entire height of the flask in order to detect and quantify sediment heights of the constituents of the control suspension. The relative turbidity of the control suspension directly depends on the concentration of the contaminants 2 separated from the grains 1 and dispersed in the control suspension. At the end of the settling duration, if the average value of the light intensity transmitted is greater than 70%, and preferably greater than 85%, the indicator is generated.

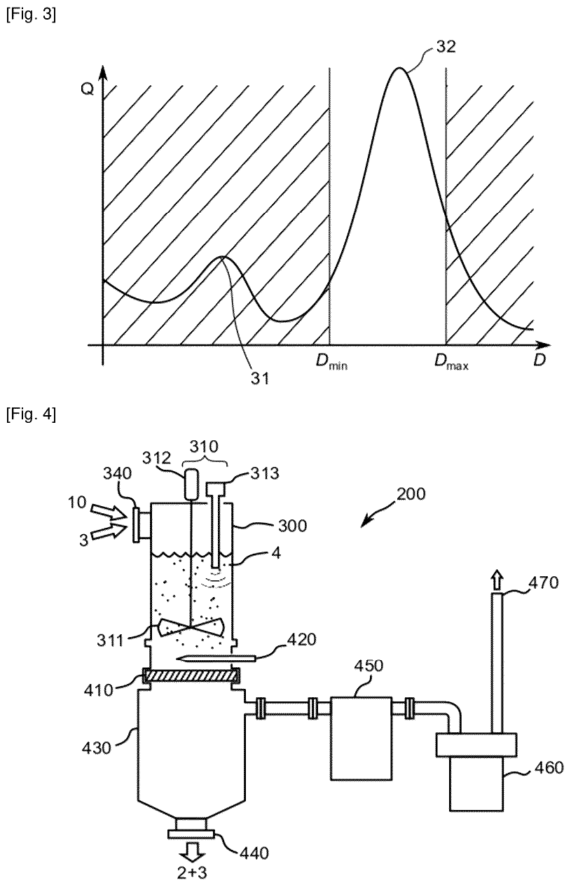

FIG. 3 shows a graph including a curve and two hatched parts. The curve is an example of the particle size distribution Q of the constituents of the raw powder 10′ as a function of the diameter D of the constituents, before the method 102 is carried out. By constituents, it is meant grains 1, contaminants 2 and macroscopic contaminants 2′. The curve is bimodal with the first peak 31 corresponding to the contaminants 2 and the second peak 32 corresponding to the grains 1. The macroscopic contaminants 2′ distort the second peak 32 by stretching it towards high diameters D. The hatched part on the left represents the action of the preparation 120, dispersion 130 and removal 140 steps on the raw powder 10′. The removal step 140, for example implemented by filtration, separates the constituents whose diameter D is less than a minimum diameter Dₘᵢₙ, that is the contaminants 2 and the molecules of solvent 3. The hatched part on the right represents the action of the sieving step 110 on the raw powder 10′. The sieving separates the constituents whose diameter D is greater than a maximum diameter Dₘₐₓ, that is the macroscopic contaminants 2′. The method 102 also offers the possibility to select the diameter D of the grains 1 by adjusting the minimum diameter Dₘᵢₙ and the maximum diameter Dₘₐₓ.

FIG. 4 schematically represents one embodiment of a device 200 configured to carry out the first mode of implementation of the method 101 for purifying the powder 10. The device 200 includes a reactor 300 within which the preparation step 120, the dispersion step 130 and partially the removal step 140 are performed. In the example of the device 200 of FIG. 4, the method 101 is implemented in batches, also called “batch mode”. However, the method 101 is compatible with a semi-continuous production mode, implementing for example a supercritical CO₂ circulation as the solvent 3.

The reactor 300 includes an inlet 340 at the top for introducing the powder 10 and the solvent 3 to form the suspension 4. The reactor 300 includes a mechanical energy source 310 for supplying mechanical energy 5 to the suspension 4. In the embodiment of FIG. 4, the mechanical energy source 310 comprises a stirring means and a sonication means. The stirring means is configured to stir the suspension 4 and provide part of the mechanical energy 5. The stirring means comprises blades 311 located in the reactor 300, connected to a motor 312. The sonication means is also configured to provide part of the mechanical energy 5. The sonication means comprises a sonotrode 313 immersed in the suspension 4. Advantageously, the stirring means and the sonification means are configured to supply mechanical energy 5 regardless of the filling level of the reactor 300 with the suspension 4, especially during the removal step 140 where the filling level drops as the solvent 3 and the contaminants 2 are removed. The reactor 300 includes a valve 420 and a filter 410 at the bottom. The valve 420 may, for example, be a diaphragm or scoop valve. The valve 420, when closed, separates the reactor 300 from the filter 410 and when open, communicates the reactor 300 with the filter 410. The removal step 140 starts with the opening of the valve 420, allowing the contaminants 2 and the solvent 3 to flow through the filter 410. In order to achieve sufficiently fast filtration, the filter 410 can be theoretically dimensioned, for example by solving the Poiseuille equation. However, it is preferable to choose a filter considering the filtration time of the filter 410 measured according to the Herzberg method, that is a filtration of 100 mL of demineralised water at 20° C. for a filtering area of 10 cm² under a water column of 50 mmCE (490 Pa). The filtration time of the filter 410 can also be measured according to DIN 53137 standard, that is the filtration of 14 ml of water at 20° C. in a freely suspended and moistened filter folded in 4, with a diameter of 125 mm.

At the end of the removal step 140, the grains 1 are placed on the filter 410 at the bottom of the reactor 300, ready for recovery. The contaminants 2 and the solvent 3 are recovered in a recovery flask 430. The recovery flask 430 may include an outlet 440 allowing it to be emptied at the end of the purification method 101. The device 200 includes a vacuum pump 460, connected to the recovery flask 430, for lowering the pressure on one side of the filter 410, in the recovery flask 430. The vacuum pump 460 thus enables the removal step 140 to be performed by vacuum filtration. An overflow flask 450 may be connected between the vacuum pump 450 and the recovery flask 430 so that the solvent 3 cannot reach the vacuum pump 460. Advantageously, the vacuum pump 460 has a discharge 470 for discharging air present in the recovery flask 430 and the overflow flask 450.

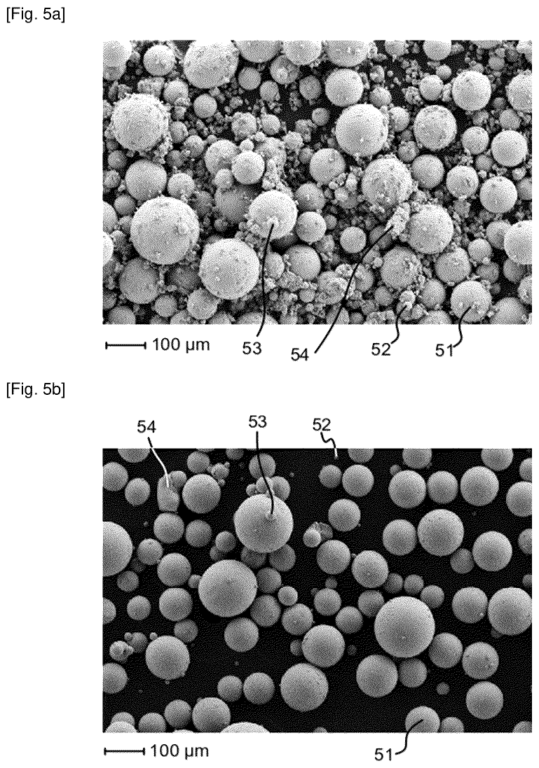

FIGS. 5a and 5b show two images obtained by scanning electron microscopy, carried out respectively on a non-purified powder and on a powder resulting from the purification method according to the invention. In the image of FIG. 5a, the non-purified powder has a large number of contaminants 52. The grains 51 include a large number of satellites 53 on the surface. Contaminants 52 also form a plurality of large aggregates 54, the sphericity of which is low. In the image of FIG. 5b, the number of contaminants 52 is small. The grains 1 include few or no satellites 53. Some aggregates 54 are present but their number is low.

According to one implementation mode of the purification method, the step of preparing the suspension including the powder and a solvent is carried out by fluidising the powder in a liquid medium. Fluidising corresponds to injecting a fluid (in liquid and/or gas phase) through a bed of solid particles. According to this embodiment of the method, a bed formed by the powder to be purified is fluidised by means of the solvent. For example, the solvent is injected under the bed of powder to be purified so that the solvent circulates up the bed of powder. The suspension is thus formed by the powder to be purified being fluidised by the solvent.

Fluidisation applies mechanical energy to the suspension, by creating circulation and turbulence, especially creating shear at the powder grains. Shearing peels the contaminants off the grains and disperses the powder grains and contaminants in the solvent.

Fluidisation of the powder also allows continuous removal of contaminants, for example by overflow. The contaminant-soiled solvent is thus pushed over the powder bed by the solvent injected under the powder bed and can thus be easily withdrawn. Fluidisation thus keeps application of mechanical energy during contaminant and solvent removal. Increasing the flow rate of the solvent injected increases mechanical energy applied to the suspension. On the other hand, it reduces the residence time of the solvent in the powder bed.

Mechanical energy from fluidisation can be increased by admixing a gas to the fluidised suspension. The gas is injected under the powder bed, for example, taking the same circuit as the solvent. The addition of the gas makes it possible to increase turbulence of the suspension and thus shear at the powder grains. This improves the dispersion of contaminants. In addition, the addition of the gas also causes contact between the powder grains creating additional shear, which can resemble attrition of the powder grains. This attrition thus enables contaminants to be removed from the powder grains more effectively.

According to one alternative, the soiled solvent can be recycled and freed of contaminants in order to be re-injected under the powder bed. For example, contaminants may be aggregated by flocculation or coagulation for subsequent liquid dispersion.

1. A method for purifying a metal powder including grains and contaminants, the method comprising:
a step of preparing a suspension including the metal powder and a solvent;
then while applying mechanical energy to the suspension:
a step of dispersing grains and the contaminants in the solvent;
a step of removing the contaminants and the solvent, mechanical energy being kept during the dispersion step and the removal step;
a step of drying the grains under a controlled atmosphere, said controlled atmosphere having an oxygen content of less than 1000 ppm.

2. The method according to claim 1, wherein mechanical energy is derived from stirring and/or sonication of the suspension.

3. The method according to claim 1, wherein a powder:solvent volume ratio in the suspension is between 1:1 and 1:50.

4. The method according to claim 1, wherein the preparation step, the dispersion step and the removal step are performed consecutively several times.

5. The method according to claim 1, wherein the method comprises further comprising a quality control step the drying step being triggered when an indicator generated by the quality control step is activated.

6. The method according to claim 5, wherein the quality control step is an analysis of the settling rate of a control suspension formed by the powder grains from the removal step which are mixed in the solvent, the indicator of the quality control step being activated if the settling rate reaches a threshold.

7. The method according to claim 5, wherein the quality control step comprises measuring the relative turbidity of the control suspension, the indicator of the quality control step being activated if the average of the transmission of a light intensity through the control suspension is greater than 70%.

8. The method according to claim 1, wherein a flow rate of the removal step is greater than 0.5 L/min.

9. The method according to claim 1, wherein the removal step implements filtration.

10. The method according to claim 1, wherein the controlled atmosphere includes a neutral gas.

11. The method according to claim 1, wherein the temperature of the grains is below 150° C. during the drying step.

12. The method according to claim 1, comprising a step of sieving macroscopic contaminants having a size that is greater than a size of the grains.

13. A device configured to implement a method for purifying a metal powder including grains and contaminants, the device comprising:
a reactor configured to:
prepare a suspension including the metal powder and a solvent; and
disperse the grains and contaminants in the solvent;
a removal means configured to remove the contaminants and the solvent;
a mechanical energy source configured to apply mechanical energy to the suspension upon dispersing the grains and contaminants in the solvent and upon removing the contaminants and solvent, mechanical energy being kept during said dispersing and removing; and
drying means configured to dry the grains under a controlled atmosphere, said controlled atmosphere having an oxygen content of less than 1000 ppm.
